(19) United States
(12) Patent Application Publication
(10) Pub. No.: US 2006/0210718 A1
(43) Pub. Date: Sep. 21, 2006

(54) Combination high density/low density layers

(75) Inventors: Edmund Aversenti, Chester, NJ (US); Allen Solomon, Grand Prairie, TX (US); Charles P. Covino, Far Hills, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: General Magnaplate Corporation, Linden, NJ (US)

(21) Appl. No.: 11/084,984

(22) Filed: Mar. 21, 2005

(51) Int. Cl. B05D 7/00; B05D 1/36; B05B 3/00

(52) U.S. Cl. 427/421.1; 427/402; 118/323

(57) ABSTRACT

A spray deposition method of making a metal mold is disclosed. The method includes spraying alternating lower and higher density layers of metallic material to form a mold.

### BACKGROUND OF THE INVENTION

Industrial processes such as molding and layup of composite materials, thermoforming, injection molding and reaction injection molding require tools having shapes specific to the article to be made. For example, a composite article can be formed in a mold having an internal shape corresponding to the shape of the desired article by laying up fibers and a matrix composition such as an epoxy or other polymeric material on the surface of the mold and curing the polymer composition. In some cases, the fibers and composition are held between two mating mold parts so that the fibers and composition are squeezed between the surfaces of the mold parts. In reaction injection molding, two or more mating mold parts are brought together to form a substantially closed cavity and a reactive polymer composition is placed within the cavity and cured to form a shape corresponding to the shape of the cavity.

There has been an ever-increasing need for large molds in numerous industries. For example, in the aerospace industry, the increasing prevalence of composite structural materials in airframes has lead to a substantial need for practical large molds. These molds often must meet demanding conditions in use. For example, composite parts used in airframes must meet exacting standards for fit and finish and often incorporate complex curved surfaces. Also, many useful materials such as carbon-fiber reinforced graphite composites must be molded at relatively high temperatures. Molds formed from alloys having low coefficients of thermal expansion such as nickel alloys are preferred for bonding these materials.

Thus, the importance of these molds is evident. However, the process of creating such molds has been somewhat difficult. While tools for fabrication of small parts are often machined from solid metals, using conventional machining techniques, these techniques are impractical in the case of very large molds, having dimensions of a meter or more. The cost of machining these large molds from solid blocks of material is prohibitive. However, there have been several innovative and cost effective methods for fabricating such molds proposed.

As described in greater detail in commonly assigned U.S. Pat. No. 5,817,267 (“the '267 patent”) and US. Pat. No. 6,447,704 (“the '704 patent”), the disclosures of which are hereby incorporated by reference herein, molds and other tools of essentially unlimited dimensions may be formed from a wide variety of metals, including low-expansion nickel and iron alloys, by a thermal spraying process. As described in certain embodiments of the '267 patent, a shell having a working surface with a desired shape can be formed by providing a matrix having the desired shape and spraying droplets of molten metal using a thermal spray gun, such as a plasma spray gun or arc spray gun onto the matrix. Such spraying can be used to build up the metal to a substantial thickness, typically about one-quarter inch (6 mm) or more. During the deposition process, the spray gun is moved relative to the matrix so that the spray gun passes back and forth over the surface of the matrix in a movement direction and so that the spray gun shifts in a step direction transverse to the movement direction between passes. Thus, during at least some successive passes, metal is deposited on the same region of the matrix from two different spray directions in a “crisscross” pattern. The resulting shells have substantial strength and good conformity with the matrix to provide a faithful reproduction of the matrix shape. Although the '267 patent is not limited by any theory of operation, it is believed that deposition of the metal in different spray directions can produce an interwoven pattern of metal droplets and/or metal grains in the deposited shell, and that this produces a stronger, generally better shell.

While the fabrication of large molds, as taught in the '267 and '704 patents, is indeed innovative and cost effective, there is room for improvement. However, molds used for certain applications must meet particular standards, such as those relating to maximum pressure loss or the like. For example, molds which resist pressure loss are often necessary in the manufacture of aircraft components. In the case of molds manufactured by utilizing the processes taught in the '267 and '704 patents, it is sometimes necessary to impregnate the molds with a polymer material in order to meet these maximum pressure loss specifications. This impregnation process, however, requires additional steps and materials, which increases both time and expense.

Therefore, still further improvements would be desirable.

### SUMMARY OF THE INVENTION

The present invention relates to the thermal spraying of tools, more specifically, the present invention relates to metallic thermal sprayed tools created by spraying a combination of high density and lower density layers.

The term density shall be understood throughout to mean the percentage of theoretical solid metal density in any particular given volume.

A first aspect of the present invention is a method of making a metallic mold. The method includes the steps of providing an active surface having a shape to be molded, spray depositing a first metal layer onto the active surface by making at least one pass with at least one first spray gun and spray depositing a second metal layer onto the first layer by making at least one pass with at least one second spray gun. The second metal layer is of a different density than the first layer. In certain embodiments, the first spray gun may be an arc spray and the second spray gun may be a powder spray gun. The method may further include repeating the spraying steps until a desired thickness of a metallic shell is achieved. Essentially the high density layers provide the desired vacuum integrity of the mold, while the lower density layers allow for the thickness of the mold to build up faster. This reduces both the cost and time required to manufacture the mold.

Another embodiment of the present invention is another method of making a metallic mold. The method includes the steps of providing a matrix having a shape to be molded, providing a spray gun assembly including a first spray gun and a second spray gun, the first spray gun being an arc spray gun and the second spray gun being a powder spray gun, spray depositing a first metal layer onto the matrix by making at least one pass with the first spray gun, spray depositing a second metal layer onto the first layer by making at least one pass with the second spray gun, repeating the spraying steps until a desired thickness of a metallic shell is achieved, and removing the shell from the matrix to form the mold. Typically, the second metal layer is of a higher density than the first metal layer.

Another aspect of the present invention is a spray gun apparatus. The spray gun apparatus includes a robotic arm controlled by a computer guidance system, a first spray gun attached to the robotic arm, the first spray gun being an arc spray gun, and a second spray gun attached to the robotic arm, the second spray gun being a powder spray gun. In accordance with this aspect, the second spray gun is configured to spray a higher density metallic layer than the first spray gun.

Yet another aspect of the present invention is a mold. The mold includes at least a first metallic layer of a first density and at least a second layer of a second density. The first and second densities, in accordance with this aspect, are different. In certain embodiments, the mold may have an exterior surface of at least one square meter.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a diagrammatic partially sectional view depicting one stage during formation of the first layer of a mold or shell in accordance with an embodiment of the present invention.

FIG. 2 is a view similar to that shown in FIG. 1 depicting the formation of the second layer onto the first layer.

### DETAILED DESCRIPTION

In describing the preferred embodiments of the subject matter illustrated and to be described with respect to the drawings, specific terminology will be used for the sake of clarity. However, the invention is not intended to be limited to any specific terms used herein, and it is to be understood that each specific term includes all technical equivalents which operate in a similar manner to accomplish a similar purpose.

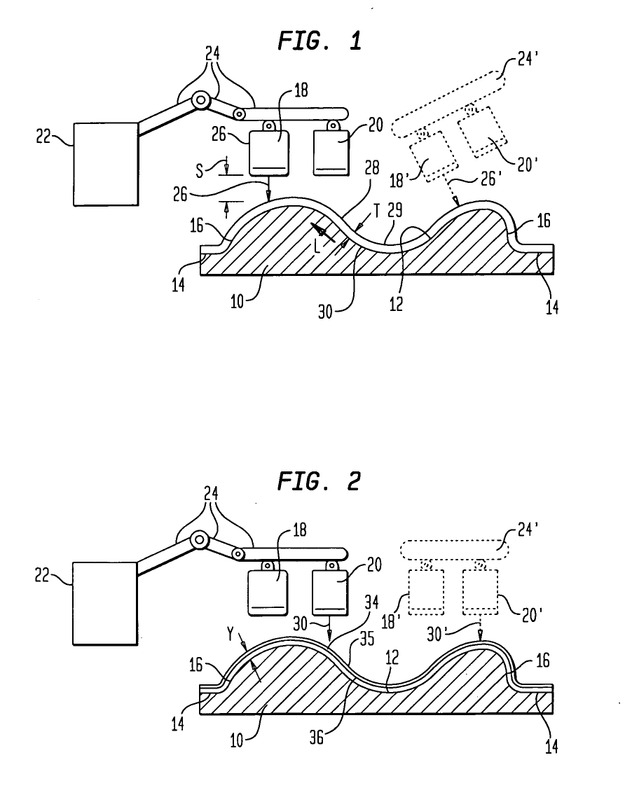

A process for making a mold in accordance with one embodiment of the present invention includes using a matrix 10 (shown in FIG. 1) having an active surface 12. Active surface 12 preferably has a shape corresponding to the shape of the part to be molded (i.e.—a mirror image). As described in greater detail in the '267 patent, matrix 10 desirably also includes edge regions 14 projecting outwardly from active surface 12 and side walls 16 extending between edge regions 14 and active surface 12. Matrix 10 can be formed from essentially any material having useful structural strength at the temperatures attained by the matrix during application of the sprayed metal (discussed below), typically on the order of 220° F. (104° C.). Similarly, matrix 10 can be formed by any conventional process. For example, high-temperature epoxy composite tooling compounds can be cast to shape using a master tool (not shown). Additionally, readily machinable materials such as polymeric materials, metals such as aluminum or brass and graphite may be machined to shape using conventional methods such as numerically controlled machining methods to form the matrix. Although matrix 10 is depicted in the figures as a solid, unitary body, it may incorporate internal structures such as hollow spaces, reinforcing members such as metal bars or fibers and the like. Also, matrix 10 typically is supported on a supporting structure such as a table or machine bed (not shown).

As shown in FIG. 1, spray guns 18 and 20 are linked to a conventional industrial robot 22. In accordance with certain preferred embodiments, spray guns 18 and 20 may be linked to robot 22 by any means that allow the spray guns to be moved in various directions relative to matrix 10. For example, as shown in FIG. 1, spray guns 18 and 20 are supported and linked to robot 22 by arms 24, which are capable of moving the spray guns in any direction with respect to matrix 10. However, it is contemplated that other modes of attachment between spray guns 18 and 20 may be employed. Robot 22 may be controlled through the use of a computer guidance program. Such programs are well known in the art for use with controlling industrial robots. Once again, however, other controls are contemplated, including but not limited to the manual operation of robot 22 by a human counterpart.

Spray guns 18 and 20 are designed such that one of the guns is configured to spray a higher density layer of metal than the other. In the embodiment shown in the Figs., spray gun 18 is a conventional arc spray gun such as that sold under the designation Model BP400 Arc Spray System by Miller Thermal, Inc. of Appleton, Wis. This spray gun is arranged to apply an electrical potential to strike an arc between a pair of wires and to continually feed the wires into the arc while blowing a stream of a compressed gas through the arc. The stream carries a spray of metal droplets formed from the molten wire at a high velocity in a relatively narrow pattern extending from the front of the gun so that the droplets move principally in a spray direction 26. The sprayed metal droplets thereafter impinge on active surface 12 of matrix 10 and deposit as a first layer 28 having a working surface 30 substantially conforming to the shape of active surface 12, walls 16, and edge regions 14 of the matrix. First layer 28 has a thickness direction T generally normal to working surface 30 and hence normal to active surface 12 of matrix 10. The layer also has lateral directions L transverse to working surface 30. Thus, the lateral directions of layer 24 (and of the formed shell as a whole) are the directions generally to the left, right and generally into and out of the plane of the drawing shown in FIG. 1. It is noted that spray gun 18 is utilized in order to spray a metallic layer over substantially all of active surface 12 of matrix 10. In certain embodiments, this may be a significant area, for example, one square meter or more.

A non-oxidizing gas such as nitrogen may be used as the gas in spraying and may be applied as a gas blanket which encapsulates the stream being sprayed. The use of such a non-oxidizing blanket minimizes oxidation of the metal during the process and promotes bonding of newly-sprayed metal to previously-sprayed metal. In a preferred embodiment, the gas blanket may be applied at the base of the spray gun so as to require the stream of metal to pass therethrough.

In certain preferred embodiments, robot 22 maintains spray gun 18 at a preselected standoff distance or spacing S from the matrix and from the deposited layer. The standoff distance will depend upon the spray conditions and the particular head employed, but most typically, in accordance with the present invention, is about 6-10 inches. As the metal is sprayed from spray gun 18, robot 20 moves the spray gun head 18 in a sweeping pattern over the active surface 12 and the adjacent walls and edge regions of the matrix. Desirably, the robot moves head 18 in a movement direction as, for example, into and out of the plane of the drawing as seen in FIG. 1 and shifts the head in a step direction transverse to the movement direction (to the left and right in FIG. 1) between passes. The robot generally situates spray gun 18 so that spray direction 26 is at a ninety degree angle with respect to active surface 12 of matrix 10 (further positions of the gun are shown in the depiction of spray gun 18′ having spray direction 26′ in FIG. 1). The “splat” or pattern of metal droplets hitting working surface 30 is assured substantially equal distribution when the spray direction 26 is situated at this ninety degree orientation with respect to active surface 12, something that is clearly desired in order to create a uniform first layer 28. However, it is contemplated that spray gun 18 may be situated so that spray direction 22 is at various angles, in certain situations, in order to more uniformly spray the metallic droplets. For example, active surfaces 12 that include severe or deep undulations may require an angled spray direction 26 to properly coat the surface with metal. The process of spraying the first layer 28 is continued until a desired thickness is achieved. For example, in certain embodiments, spray gun passes are made until thickness T is approximately 0.040 to 0.062 inches at every point over the entire area of first layer 28.

The material used to form first or first layer 28 is selected for compatibility with the material to be molded. Particularly in those applications involving elevated temperatures or substantial temperature changes during the molding operation, the material used to form the first layer is selected to have a low coefficient of thermal expansion and to provide substantial strength at elevated temperature. Merely by way of example, materials such as aluminum alloys, ferrous metals such as stainless steels and iron-nickel alloys can be used. Alloys formed predominantly from iron and nickel are particularly preferred for this purpose. As used in this disclosure, a metal formed “predominantly from” certain metals contain at least about 50% of those metals in the aggregate. Thus, a metal formed predominantly from iron and nickel contains at least about 50% iron and nickel in the aggregate and 50% or less of other materials by weight. Alloys of iron and nickel containing between about 30% and about 55% nickel and between about 45% and about 70% iron are particularly preferred. The most preferred low-expansion alloys are those containing about 36% nickel, such as those sold under the commercial designation Invar.

In the above described embodiment, first layer 28 is sprayed as a relatively low density layer. This may be due in part to the constriction of spray gun 18, the material utilized or both. It should be understood that such a low density layer will build a thickness T with less material (and most likely less spray gun passes), than a higher density spray. Therefore, this layer is usually more cost effective and timely, than a higher density layer.

Once the desired thickness T of first layer 28 is achieved, a similar process is performed utilizing Spray gun 20. In certain preferred embodiments, spray gun 20 is a powder spray gun designed to spray a higher density layer of metal, than that of the aforementioned arc spray gun 18. One example of spray gun 20 is a conventional powder spray gun such as that sold under the designation Metcp PJF 900 by Sulzer Metco of Switzerland, This spray gun is arranged such that molten metallic powder is induced into a high velocity gas stream blanketed by nitrogen, and is throw at a substrate less than approximately 12 inches away. The stream carries a spray of metal droplets from the front of the gun so that the droplets move principally in a spray direction 32. This type of powder spray gun allows for the spray droplets to move at a higher velocity so as to spray a higher density stream. It is noted that the speed of operation of robot 22 is typically increased during the operation of second spray gun 20, in order to properly correspond to this higher density stream.

Like that of spray gun 18, spray gun 20 sprays metal droplets that impinge on the outer surface 29 of first layer 28 and deposit as a second layer 34 having a working surface 36 substantially conforming to the shape of outer surface 29 of the first layer. Second layer 34 is substantially similar to first layer 28 except that second layer 34 has a thickness direction U generally normal to outer surface 29 of first layer 28. As shown in FIG. 2, spray gun 20 is operated in substantially the same way as spray gun 18 and may utilize similar metallic materials, to ultimately create a second layer that is, in certain embodiments, approximately 0.025 inches at every point over its entire area. However, other thicknesses are contemplated. As mentioned above, spray gun 20 is designed to spray a higher density coating layer, which provides a second layer with lower porosity than the first layer. Stated another way, the second layer has higher density than the first layer. The second layer reduces the porosity of the first and second layer combination. This denser second metal layer allows a tool to be created that may achieve the same reduction in pressure loss as other tools that are spray deposited and then impregnated with a polymeric substance.

Once again, the higher density of second layer 34 may be due in part to the construction of spray gun 20, the material utilized, or both. However, deposition of this higher density second layer, typically requires more spraying or time per unit volume, or per unit thickness than deposition of the first layer. Therefore, thickness U is preferably less than thickness T of the first layer. Essentially, this differing density second layer 34 works in combination with first layer 28 to create a single mold with low porosity and low pressure loss without requiring a single high density material throughout. This is important for cost effectiveness and reduction in time needed to spray up the mold. Spraying a mold completely consisting of a high density layer, like second layer 34, would be costly. That is why a polymeric material has been typically impregnated into the mold, so as to allow the mold to meet the above-discussed pressure loss standards. The preferred embodiment of the present invention provides a mold that meets these exacting standards by balancing the use of high density material with more conventional low density material.

The above steps may be repeated, thereby creating a shell with alternating lower and higher density layers (like that of first layer 28 and second layer 34). Essentially, a third layer (not shown) of similar construction to that of first layer 28 is sprayed onto outer surface 35 of second layer 34. Thereafter, identical steps to those described above are repeated. It is contemplated that the thicknesses of the individual layers may vary through the created shell. For example, each layer may have different thicknesses or similar layers may have similar thicknesses. Similarly, each layer may be created by utilizing similar materials, or may vary accordingly. Additionally, the method according to the present invention is not required to be conducted by spraying a low density layer as first layer and a high density later as second layer, and so forth. Rather, first layer may be high density while second layer is a lower density.

The above steps may be repeated until an overall desired shell thickness is achieved. For example, in certain embodiments, the shell consists of three 0.062 inch lower density layers that are similar in nature to first layer 28, and two 0.025 inch higher density layers that are similar in nature to second layer 34. Thus, the shell in accordance with these embodiments would have an overall thickness of approximately 0.236 inches. However, it is contemplated that other metal layer combinations can be utilized to achieve many different shell thicknesses.

The end result of the above discussed steps is to form an integral, unitary shell, incorporating the different density metal spray deposited layers. The shell created utilizing the process according to the preferred embodiment of the present invention preferably meets well known vacuum integrity specifications without the need to impregnate same with a polymeric material. For example, as with molds utilized in the aerospace industry, certain shells created utilizing the process in accordance with embodiments of the present invention meet a well known specification that requires the maximum pressure loss not to exceed 2.0 inches Hg in a five minute time period. This has typically only been achieved by impregnating a similar shell, having a similar thickness, with the above discussed polymeric material.

The shell has a working surface corresponding to working surface 30 of first layer 28, which conforms to active surface 12 of matrix 10. As described in greater detail in the '267 patent, the shell can be allowed to cool gradually, desirably over a period of several hours and preferably over a longer time before being removed from matrix 10. For example, very large molds may be cooled from about 150° C. to about 20° C. over a period of several weeks in a temperature controlled environment with subsequent cooling at normal room temperature. It is believed that such gradual cooling tends to stabilize the shell and prevent warpage when the shell is removed from matrix 10. As also described in the '267 patent, those portions of shell extending along side walls 16 of matrix 10 form ribs projecting from the remainder of the shell which further tend to stiffen the shell and reinforce it against warpage. Those ribs may remain in place in the finished shell or else may be removed after cooling.

The completed shell can be used as a mold or a mold component. For example, in reaction injection molding or blow molding, two such assemblies can be engaged with one another so that their shells form a closed cavity and a molten composition can be squeezed between the shells. In other processes such as thermoforming and some lay up processes, only one shell is employed.

As described in the '267 patent, the mold surfaces can be polished or otherwise treated to provide the desired surface finish. However, the metal layers formed by thermal spraying according to the preferred embodiment of the present invention are dense and substantially non-porous. Thus, the working surfaces of the mold normally need not be impregnated with a polymer or with a metal such as nickel by electroplating or electroless plating. However, such treatments can be used if desired.

Numerous variations and combinations of the features discussed above can be employed without departing from the present invention. It is contemplated that the above discussed steps for forming shell can be modified in accordance with certain embodiments of the present invention. For example, any number of passes can be made with either spray gun to achieve any desired thickness. Similarly, it is not essential to form every metal layer by spray deposition. For example, the first or underlying layer 28 can be formed in part or in whole by other processes, such as by plating and the remaining thickness of the shell can be formed by the steps as discussed above.

It is also contemplated that the above method may be performed utilizing a single gun having both arc and powder spray gun properties. Essentially, rather than making passes with each gun, only one assembly would be required to form the mold. This may allow for the faster formation of the mold surface, while retaining the aforementioned mold benefits. As with the above apparatus, it is also contemplated to control such a spray gun with a robotic assembly or the like. However, rather than having a multiple gun assembly, the robot would merely control and move a single gun assembly.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of making a metallic mold comprising the steps of:
(a) providing an active surface having a shape to be molded;
(b) spray depositing a first metal layer onto to substantially all of the active surface by making at least one pass with at least one first spray gun; and
(c) spray depositing a second metal layer onto the first layer by making at least one pass with at least one second spray gun, the second metal layer being of a different density than the first metal layer.

2. The method according to claim 1, wherein the first spray gun is an arc spray gun and the second spray gun is a powder spray gun.

3. The method according to claim 1, further comprising repeating steps (b) and (c) until a desired thickness of a metallic shell is achieved.

4. The method according to claim 3, wherein said spraying steps include making multiple passes with said spray guns.

5. The method according to claim 4, wherein said spraying steps include making at least one pass with either spray gun having a spray direction at an oblique angle to a surface defined by the matrix.

6. The method according to claim 3, further comprising the step of removing the shell from the matrix to form the mold and using the mold in a molding process.

7. The method according to claim 3, wherein said steps are repeated until the shell is at least 0.1 inches thick.

8. The method according to claim 7, wherein said step are repeated until the shell is about 0.25 inches thick.

9. The method according to claim 3, wherein the shell has an exterior surface area of at least one square meter.

10. The method according to claim 2, wherein the arc gun is a Model BP400 Arc Spray System.

11. The method according to claim 2, wherein the powder spray gun is a Metcp PJF 900.

12. The method according to claim 1, wherein the first metal layer is constructed from the group consisting of iron, nickel, zinc, aluminum and/or copper.

13. The method according to claim 12, wherein the second metal layer is a higher density layer constructed from the group consisting of iron, nickel, zinc, aluminum and/or copper.

14. The method according to claim 1, further comprising the step of forming a composite part in the mold.

15. The method according to claim 1, wherein the at least one first spray gun and the at least one second spray gun are both attached to a movement device.

16. The method according to claim 15, wherein the movement device is a robotic arm controlled through a computer guidance system.

17. The mold made by the method according to claim 1.

18. A spray gun apparatus comprising:
a robotic arm controlled by a computer guidance system;
a first spray gun attached to the robotic arm, said first spray gun being an arc spray gun; and
a second spray gun attached to the robotic arm, said second spray gun being a powder spray gun, wherein said second spray gun is configured to spray a higher density metallic layer than said first spray gun.

19. A method of making a metallic mold comprising the steps of:
(a) providing a matrix having a shape to be molded;
(b) providing a spray gun assembly including a first spray gun and a second spray gun, the first spray gun being an arc spray gun and the second spray gun being a powder spray gun;
(c) spray depositing a first metal layer onto to the matrix by making at least one pass with the first spray gun;
(d) spray depositing a second metal layer onto the first layer by making at least one pass with the second spray gun, the second metal layer being of a higher density than the first metal layer;
(e) repeating steps (c) and (d) until a desired thickness of a metallic shell is achieved; and
(f) removing the shell from the matrix to form the mold.

20. A mold comprising:
at least a first metallic layer of a first density; and
at least a second layer of a second density, wherein the first and second densities are different.

21. The mold of claim 20, wherein said mold has a surface area of at least one square meter.
